(19) United States
(12) Patent Application Publication
(10) Pub. No.: US 2026/0237577 A1
(43) Pub. Date: Aug. 13, 2026

(54) MAGNETIC DAMPING ROLLER STRUCTURE

(71) Applicant: SHENZHEN LOYAL ELECTRONICS CO., LTD., Shenzhen (CN)

(72) Inventors: Shaojuan CHEN, Guangdong (CN); Qiaolong JU, Guangdong (CN); Junliang LIU, Guangdong (CN)

(73) Assignee: SHENZHEN LOYAL ELECTRONICS CO., LTD., Shenzhen (CN)

(21) Appl. No.: 19/438,088

(22) Filed: Dec. 31, 2025

(30) Foreign Application Priority Data
Feb. 7, 2025 (CN) 202510135402.0
Aug. 29, 2025 (CN) 202511224343.0

(51) Int. Cl. H01H 19/11; G06F 3/0354; G06F 3/0362

(52) U.S. Cl. CPC H01H 19/11; G06F 3/03543; G06F 3/0362

(57) ABSTRACT

A magnetic damping roller structure includes: a mounting base; a first annular bearing, fixed at the mounting base, where at least one side surface of the first annular bearing is uniformly arranged with a plurality of first protrusions; a second annular bearing, rotatably arranged at the mounting base, where the second annular bearing and the first annular bearing are coaxially arranged, a plurality of second protrusions are uniformly arranged at a surface of one side of the second annular bearing facing the first protrusion. The first protrusion and the second protrusion are arranged in one-to-one correspondence. Damping generated by magnetic attraction between the first protrusion and the second protrusion provides the magnetic damping roller structure with tactile feedback having different notched feedback.

### CROSS-REFERENCE TO RELATED APPLICATIONS

The present application claims priority to Chinese Patent Application No. 202510135402.0, filed on Feb. 7, 2025, and Chinese Patent Application No. 202511224343.0, filed on Aug. 29, 2025, the content of all of which is incorporated herein by reference.

### FIELD

The present disclosure relates to the technical field of electronic components, in particular to a magnetic damping roller structure.

### BACKGROUND

A magnetic damping roller structure is a rotational structure that generates a magnetic damping effect through a magnetic material. The structure can be applied in fields such as a scroll wheel of a keyboard or a mouse, a knob of a car infotainment system, a control knob of a household appliance, etc. The magnetic damping of the magnetic damping roller structure is mainly configured to control the rotational speed of the rotational structure or provide the damping effect. The magnetic damping effect improves the hand-feel experience of users during use and makes the rotation of the rotational structure smoother and more controllable. Compared with conventional encoder rollers that rely on contact friction with metal tabs, a non-contact magnetic damping effect is employed to extend the service life of a roller wheel. For example, a scroll wheel is commonly provided in a computer mouse. When a user scrolls the mouse wheel, in order to improve tactile feel and controllability of page scrolling on a computer display, the scroll wheel is required to provide notched feedback and damping feedback.

However, taking a mouse scroll wheel as an example, scroll wheel in the current magnetic damping mouse is usually a damping generation wheel formed by splicing multiple small magnets around a central axis to provide damping sensation to the mouse scroll wheel. The damping generation wheel formed by splicing the small magnets has a complex structure, and the assembly of the small magnets during production is prone to misalignment, resulting in rework and ultimately leading to a higher production cost for magnetic damping mouse scroll wheels. Additionally, existing magnetic damping mouse wheels generally have fixed internal structures and fixed magnetic strength. As a result, the notched feedback and damping feedback during rotation are typically fixed and not adjustable. Users are therefore unable to adjust the magnitude of the damping feedback of the scroll wheel according to personal preference.

Therefore, the above-mentioned technical defects urgently need to be improved.

### SUMMARY

In view of the above-mentioned defects of the prior art, the present disclosure provides a magnetic damping roller structure to simplify magnetic damping roller structure, and enable adjustment of both damping magnitude and notched force of the roller during rotation, thereby allowing adjustment of a tactile feel of the roller. In addition, kinetic energy generated during rotation of the roller can be converted into electrical energy, thereby achieving an energy-harvesting effect.

Technical solutions adopted in the present disclosure to solve the technical problems are as follows: a magnetic damping roller structure and a damping adjustment method are closed, the magnetic damping roller structure includes:
a mounting base;
a first annular bearing, fixed at the mounting base, at least one side surface of the first annular bearing is uniformly arranged with a plurality of first grooves, and a first protrusion is formed between adjacent two first grooves; and
at least one second annular bearing, rotatably arranged at the mounting base, wherein the second annular bearing and the first annular bearing are coaxially arranged together, a plurality of second grooves are uniformly arranged at a surface of one side of the second annular bearing facing the first protrusion, and a second protrusion is formed between adjacent two second grooves;
while a gap is formed between the first protrusion and the second protrusion, and the first protrusion and the second protrusion are arranged in one-to-one correspondence and generate attraction magnetic forces.

In one implementation of the present disclosure, the first annular bearing and the second annular bearing are integrally formed annular magnetic bearings, which leads to the first protrusion and the second protrusion being protruding structures, and the magnetic damping of the magnetic damping roller structure is generated by the magnetic force between the first protrusion and the second protrusion.

In another implementation of the present disclosure, at least one magnetic coil is arranged on the first annular bearing, the magnetic coil is configured to adjust a magnetic magnitude of the first annular bearing, thereby changing the magnetic force between the first annular bearing and the second annular bearing to adjust the magnetic damping of the magnetic damping roller structure.

Compared with the prior art, the present disclosure provides a magnetic damping roller structure. In the present disclosure, damping is generated by the magnetic attraction between the first protrusion and the second protrusion to provide a notched feedback; the magnetic field strength of the first annular bearing is adjusted by controlling the magnitude and direction of the current applied to the magnetic coil, thereby adjusting the magnetic attraction between the first protrusion and the second protrusion, so that the damping magnitude during rotation of the second annular bearing is adjustable. In addition, the magnetic coil can cut magnetic flux lines to convert kinetic energy of the second annular bearing into electrical energy, thereby achieving an energy-harvesting effect. The present disclosure can be applied to devices such as mice, keyboards, and automotive instrument panels.

### BRIEF DESCRIPTION OF THE DRAWINGS

In order to provide a clearer description of the technical solutions in the embodiments of the present disclosure or in the prior art, a brief introduction is given to the accompanying drawings required for the description of the embodiments or the prior art. It is obvious that the accompanying drawings described below are some embodiments of the present disclosure. For those skilled in the art, other drawings can be obtained based on these drawings without creative labor.

FIG. 1 is a schematic diagram of an overall structure of a magnetic damping roller structure according to one implementation of the present disclosure.

FIG. 2 is a schematic diagram of an overall structure of the magnetic damping roller structure from another perspective according to one implementation of the present disclosure.

FIG. 3 is a schematic diagram of an exploded structure of the magnetic damping roller structure according to one implementation of the present disclosure.

FIG. 4 is a schematic diagram of an exploded structure of the magnetic damping roller structure from another perspective according to one implementation of the present disclosure.

FIG. 5 is a schematic diagram of exploded structures of a first annular bearing and a second annular bearing of the magnetic damping roller structure according to one implementation of the present disclosure.

FIG. 6 is a schematic diagram of exploded structures of the first annular bearing and the second annular bearing of the magnetic damping roller structure from another perspective according to one implementation of the present disclosure.

FIG. 7 is a schematic diagram of a structure of the second annular bearing of the magnetic damping roller structure according to one implementation of the present disclosure.

FIG. 8 is a schematic diagram of an overall structure of a magnetic damping roller structure according to another embodiment in one implementation of the present disclosure.

FIG. 9 is a schematic diagram of an exploded structure of the magnetic damping roller structure according to another embodiment in one implementation of the present disclosure.

FIG. 10 is a schematic diagram of another exploded structure of the magnetic damping roller structure according to another embodiment in one implementation of the present disclosure.

FIG. 11 is a schematic diagram of an overall structure of a magnetic damping roller structure according to another implementation of the present disclosure.

FIG. 12 is a schematic diagram of an overall structure of the magnetic damping roller structure from another perspective according to another implementation of the present disclosure.

FIG. 13 is a schematic diagram of an exploded structure of the magnetic damping roller structure according to another implementation of the present disclosure.

FIG. 14 is a schematic diagram of an exploded structure of the magnetic damping roller structure from another perspective according to another implementation of the present disclosure.

FIG. 15 is a schematic diagram of exploded structures of a first annular bearing and a second annular bearing of the magnetic damping roller structure according to another implementation of the present disclosure.

FIG. 16 is a schematic diagram of exploded structures of the first annular bearing and the second annular bearing of the magnetic damping roller structure from another perspective according to another implementation of the present disclosure.

FIG. 17 is a schematic diagram of a structure of the first annular bearing of the magnetic damping roller structure according to another implementation of the present disclosure.

FIG. 18 is a schematic diagram of a structure of the second annular bearing of the magnetic damping roller structure according to another implementation of the present disclosure.

FIG. 19 is a schematic diagram of an overall structure of a magnetic damping roller structure according to another embodiment in another implementation of the present disclosure.

FIG. 20 is a schematic diagram of an exploded structure of the magnetic damping roller structure according to another embodiment in another implementation of the present disclosure.

FIG. 21 is a schematic diagram of another exploded structure of the magnetic damping roller structure according to another embodiment in another implementation of the present disclosure.

### DETAILED DESCRIPTION OF THE EMBODIMENTS

The embodiments of the present disclosure are described in detail below and are shown in the accompanying drawings. Identical or similar reference numerals from beginning to end represent identical or similar components or components with identical or similar functions. The embodiments described below with reference to the accompanying drawings are exemplary and are only used to illustrate the present disclosure, and should not be understood as limiting the present disclosure.

In the description of the present disclosure, it should be understood that the terms “center”, “transverse”, “longitudinal”, “up”, “down”, “front”, “rear”, “left”, “right”, “vertical”, “horizontal”, “top”, “bottom”, “inside”, “outside” and other directional or positional relationships indicated are based on the directional or positional relationships shown in the accompanying drawings, only for the convenience of simplifying the description of the present disclosure, and do not indicate or imply that the apparatus or component referred to must have a specific orientation and be constructed and operated in a specific orientation, and therefore cannot be understood as a limitation of the present disclosure. In addition, the terms “first” and “second” are only used for descriptive purposes and cannot be understood as indicating or implying relative importance or the number of technical features. Thus, the features limited to “first” and “second” may explicitly or implicitly include one or more of these features. In the description of the present disclosure, unless otherwise specified, “multiple” and “plurality” refer to two or more.

In the description of the present disclosure, it should be noted that unless otherwise specified and limited, the terms “arrange”, “set”, “provide”, “install”, and “connect” should be broadly understood. For example, it can be a fixed connection, a detachable connection, or an integral connection. It can be a directly connection or an indirectly connection through an intermediate component. For those ordinary skilled in the art, the specific meanings of the above terms in the present disclosure can be understood in specific situations.

In addition, the technical features involved in different embodiments of the present disclosure described above can be combined with each other as long as they do not conflict with each other.

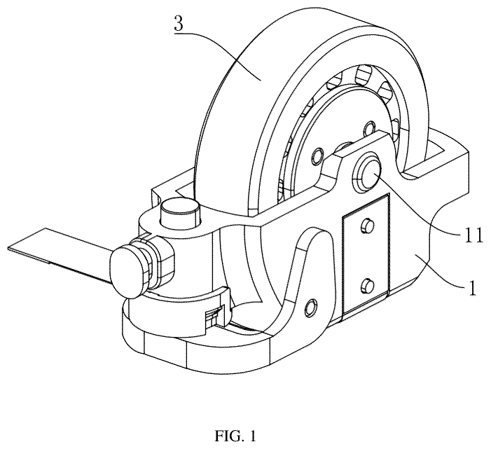

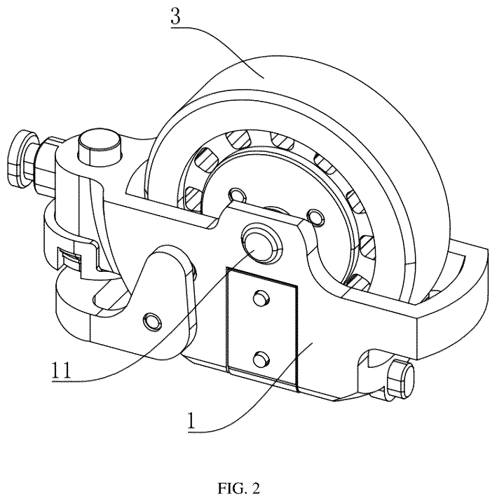

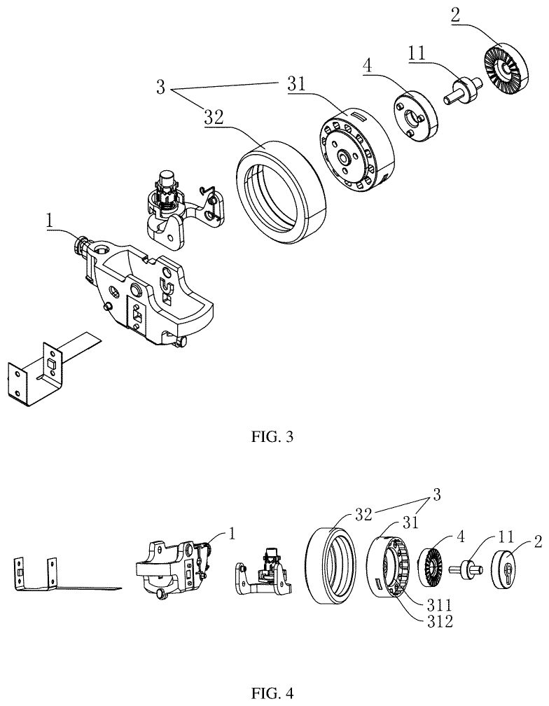

The present disclosure provides a magnetic damping rotational structure as shown in FIG. 1, FIG. 2, and FIG. 3, which is a rotational structure that generates a magnetic damping effect through a magnetic material. The application range of the magnetic damping rotational structure is very wide, such as a scroll wheel of a keyboard or a mouse, a knob of a car infotainment system, a control knob of a household appliance, etc. The magnetic damping of the magnetic damping rotational structure is mainly configured to control the rotational speed of the rotational structure or provide the damping effect. This improves the hand-feel experience of users during use and makes the rotation of the rotational structure smoother and more controllable. A main structure of the present disclosure includes: a mounting base 1, a first annular bearing 2, and at least one second annular bearing 4. The first annular bearing 2 is fixed on the mounting base 1, and at least one side surface of the first annular bearing 2 is uniformly arranged with a plurality of first grooves 21. A first protrusion 22 is formed between adjacent two first grooves 21. The second annular bearing 4 is rotatably arranged on the mounting base 1. The second annular bearing 4 and the first annular bearing 2 are coaxially arranged together. The surface of one side of the second annular bearing 4 facing the first protrusion 22 is uniformly arranged with a plurality of second grooves 41, and a second protrusion 42 is formed between adjacent two second grooves 41.

There is a gap formed between the first protrusion 22 and the second protrusion 42, and the first protrusion 22 and the second protrusion 42 are arranged in one-to-one correspondence and generate attraction magnetic forces. In some embodiments, a connecting shaft is located between and passes the first protrusion 22 and the second protrusion 42.

In one implementation, the first annular bearing 2 and the second annular bearing 4 are integrally formed annular magnetic bearings, and the side surfaces of the first annular bearing 2 and the second annular bearing 4 that face each other have opposite magnetic polarities. Accordingly, the first protrusion 22 and the second protrusion 42 are both protruding structures, and a magnetic attraction force is generated between the first protrusion 22 and the second protrusion 42. By the magnetic attraction force between opposite magnetic poles of the first protrusion 22 and the second protrusion 42, magnetic damping of the magnetic damping roller structure is generated when the second annular bearing 4 rotates relative to the first annular bearing 2.

The mounting base 1 is configured to mount and fix various structural components. Different functional components can be set at the mounting base 1 according to functional requirements, such as a rotatable switch, a photoelectric switch, etc. The mounting base 1 is arranged with a connecting shaft 11, which in some embodiments is configured as a metal shaft to ensure the structural strength and durability of the rotational structure. The first annular bearing 2 is sleeved on the connecting shaft 11 and fixed on the mounting base 1. At least one side surface of two side surfaces of the first annular bearing 2 is uniformly arranged with a plurality of first grooves 21, and the plurality of first grooves 21 extend in a direction deviating from an axis of the first annular bearing 2. A first protrusion 22 is formed between adjacent two first grooves 21. The arrangement of the first grooves 21 can weaken the magnetic properties at the location of each first groove 21; therefore, the attraction magnetic force of the side surface of the first annular bearing 2 can be uniformly distributed at the plurality of first protrusions 22. An outer ring wheel 3 is sleeved on the connecting shaft 11. The second annular bearing 4 is arranged at an axis of the outer ring wheel 3 and located at a side surface of the first annular bearing 2. The surface of one side of the second annular bearing 4 near the first protrusion 22 is uniformly arranged with a plurality of second grooves 41. The plurality of second grooves 41 extend in a direction deviating from an axis of the second annular bearing 4, and a second protrusion 42 is formed between adjacent two second grooves 41. Similarly, the arrangement of the second groove 41 can weaken the magnetic properties at the location of each second groove 41; therefore, the attraction magnetic force of the side surface of the second annular bearing 4 can be uniformly distributed at the plurality of second protrusions 42. The first protrusion 22 and the second protrusion 42 are set in one-to-one correspondence through attraction magnetic forces, and a gap is formed between the first protrusion 22 and the second protrusion 42. In some embodiments, the connecting shaft 11 is coaxially arranged with a shaft step located between the first protrusion 22 and the second protrusion 42. The gap and the coaxial connection between the first protrusion 22 and the second protrusion 42 are maintained by the shaft step. In some embodiments, the shaft step is integrally formed with the connecting shaft 11, and both the shaft step and the connecting shaft 11 are non-magnetic material structures to avoid disturbing the magnetic fields of the first protrusion 22 and the second protrusion 42.

It can be seen that the first annular bearing 2, the second annular bearing 4, and the outer ring wheel 3 are directly or indirectly sleeved on the connecting shaft 11. When the outer ring wheel 3 is scrolled, the second annular bearing 4 rotates synchronously. At this point, the axial attraction magnetic forces between adjacent two magnetic surfaces of the second annular bearing 4 and the first annular bearing 2 change, so that the damping value of the outer ring wheel 3 changes during rotation, resulting in the notched feedback of hand-feel weight.

It should be noted that, taking the mouse scroll wheel as an example, notched feedback and damping feedback are required when the mouse scroll wheel is scrolled, so that users can better control computer pages. However, the current magnetic damping mouse scroll wheel is usually a damping generation wheel formed by splicing multiple small magnets around a central axis to provide damping sensation to the mouse scroll wheel. The damping generation wheel formed by splicing the small magnets has a complex structure, and the assembly of the small magnets during production is prone to misalignment, resulting in rework and ultimately leading to a higher production cost for magnetic damping mouse scroll wheels.

This technical solution divides the side surface of the first annular bearing 2 into a plurality of first protrusions 22 around the central axis using the first grooves 21, so that the magnetic strength of the side surface of the first annular bearing 2 is uniformly distributed at the plurality of first protrusions 22. Similarly, the magnetic strength of the side surface of the second annular bearing 4 is uniformly distributed at he plurality of second protrusions 42. When the second annular bearing 4 rotates slowly, the damping value changes due to the attraction between the first annular bearing 2 and the second annular bearing 4, resulting in the notched feedback of hand-feel weight, effectively improving the damping effect. When the outer ring wheel 3 rotation accelerates, utilizing torque inertia can make the second annular bearing 4 rapidly rotate until the rotational speeds of the outer ring wheel 3 and the second annular bearing 4 slow down to a point where damping cannot be overcome, and then slow down to a stop.

In another embodiment of the present implementation, a first annular bearing 2 and two second annular bearings 4 are coaxially arranged on the connecting shaft 11, and both the first annular bearing 2 and the connecting shaft 11 are fixedly connected to the mounting base 1. A plurality of first grooves 21 are uniformly arranged on both side surfaces of the first annular bearing 2, and a first protrusion 22 is formed between adjacent two first grooves 21. Two second annular bearings 4 are respectively rotatable arranged on the mounting base 1. The surface of one side of the second annular bearing 4 facing the first protrusion 22 is uniformly arranged with a plurality of second grooves 41, and a second protrusion 42 is formed between adjacent two second grooves 41. There are gaps between the two second protrusions 42 and two ends of the first protrusion 22. The first protrusion 22 and the second protrusion 42 are arranged in one-to-one correspondence and generate attraction magnetic forces.

Two second annular bearings 4 are respectively arranged at two ends of the first annular bearing 2, and there is a magnetic damping effect between any one of the two second annular bearings 4 and the first annular bearing 2.

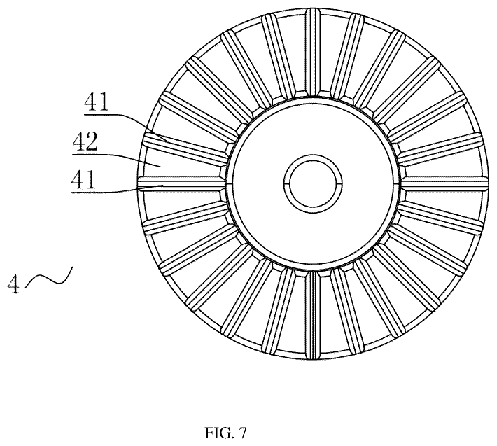

In practical applications, the dual-magnetic damping scroll wheel structure in this embodiment can ensure better magnetic damping effects during scroll wheel rotation. The structural design is simpler and more compact, and can be applied to the scroll wheel control requirements of a dual-scroll wheel mouse or car infotainment system to achieve scrolling functions of more scroll wheels. Furthermore, as shown in FIG. 6 and FIG. 7, magnetic poles of the first protrusion 22 and the second protrusion 42 are opposite. It can be understood that the opposite magnetic poles of the first protrusion 22 and the second protrusion 42, can make the first protrusion 22 and the second protrusion 42 attract each other, so as to improve the magnetic damping effect generated between the first protrusion 22 and the second protrusion 42.

Furthermore, as shown in FIG. 6 and FIG. 7, the number of the first grooves 21 is the same as the number of the second grooves 41, the size of the first protrusion 22 is the same as the size of the second protrusion 42, and the shape of the first protrusion 22 is the same as the shape of the second protrusion 42.

It can be understood that in order to make the notched feedback during the rotation of the magnetic damping rotational structure clearer, the number of the first grooves 21 and the number of the second grooves 41 need to be the same, the size of the first protrusion 22 and the size of the second protrusion 42 need to be the same, and the shape of the first protrusion 22 and the shape of the second protrusion 42 need to be the same.

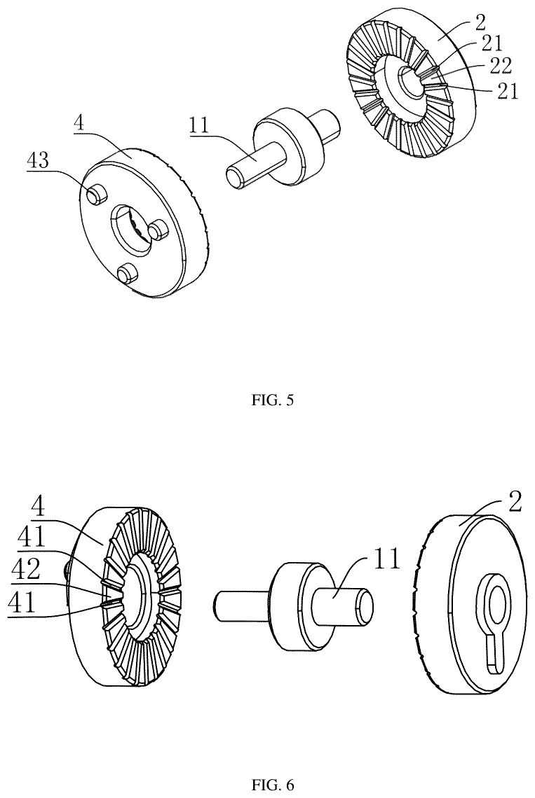

Furthermore, as shown in FIG. 5 and FIG. 6, both the first groove 21 and the second groove 41 are V-shaped grooves. The arrangement of the V-shaped grooves allows the protrusions (the first protrusion 22 and the second protrusion 42) to present a structure with a wider bottom and a narrower top. This structural design allows the attraction magnetic forces of the magnetic side surfaces of the annular bearings (the first annular bearing 2 and the second annular bearing 4) to concentrate along slopes of the V-shaped grooves at a top of the protrusions (the first protrusion 22 and the second protrusion 42) making the notched feedback between the first annular bearing 2 and the second annular bearing 4 clearer, and improving the magnetic damping effect between the first annular bearing 2 and the second annular bearing 4.

Furthermore, an outer ring wheel 3 is coaxially arranged on the second annular bearing 4, and the outer ring wheel 3 is detachably connected to the second annular bearing 4.

Furthermore, as shown in FIG. 3, FIG. 4, and FIG. 5, the second annular bearing 4 is arranged with a plurality of positioning pins 43, and is fixedly connected to the outer ring wheel 3 through the plurality of positioning pins 43. The second annular bearing 4 is connected to the outer ring wheel 3 through the positioning pins 43, which can prevent slippage between the second annular bearing 4 and the outer ring wheel 3. In some embodiments, the second annular bearing 4 is detachably connected to the outer ring wheel 3.

Furthermore, as shown in FIG. 3 and FIG. 4, the outer ring wheel 3 includes a grating clamp ring 31 and an outer rim 32. The grating clamp ring 31 and the second annular bearing 4 are coaxially arranged together, and a plurality of light pass holes 312 are arranged in a circumferential direction of the grating clamp ring 31. An extension direction of the through holes 312 is parallel to an axis direction of the grating clamp ring 31. The outer rim 32 is sleeved on an outer side wall of the grating clamp ring 31.

Furthermore, as shown in FIG. 4, a clearance groove 311 is arranged at the axis of the grating clamp ring 31 and is configured to accommodate the first annular bearing 2 and the second annular bearing 4. The first annular bearing 2 and the second annular bearing 4 are accommodated in the clearance groove 311 at the axis of the grating clamp ring 31, which can make the entire rotational wheel structure more compact and integrated. Moreover, the wheel structure including the first annular bearing 2, the second annular bearing 4, and the grating clamp ring 31 is more reasonable.

Furthermore, the outer rim 32 is a metal rim. The greater mass of the metal rim results in a greater rotational inertia of the outer rim 32, thereby making the rotation stroke of the outer rim 32 longer.

The present disclosure further provides a magnetic damping generation method based on any one of the magnetic damping roller structures described above, the magnetic damping generation method includes the following steps:
Step 1: Driving, by the outer ring wheel 3, the second annular bearing 4 to rotate when the outer ring wheel 3 is scrolled by a user;
Step 2: Rotating the second annular bearing 4 to cause a displacement between the first protrusion 22 and the second protrusion 42, where the first protrusion 22 and the second protrusion 42 are in one-to-one correspond, have opposite magnetic poles, and attract each other; and
Step 3: Changing an attraction magnetic force between the first protrusion 22 and the second protrusion 42 to generate damping between the first protrusion 22 and the second protrusion 42.

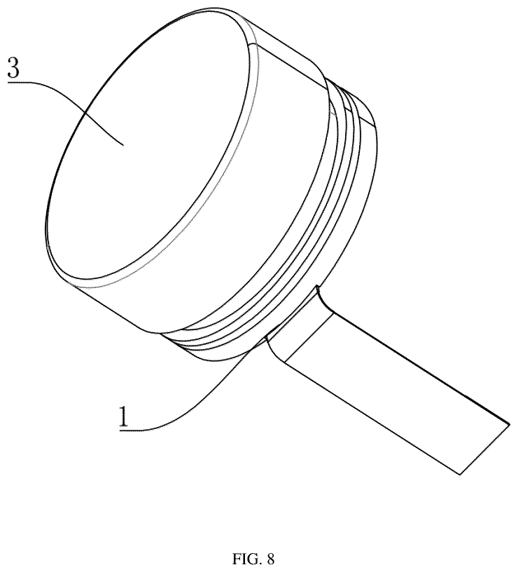

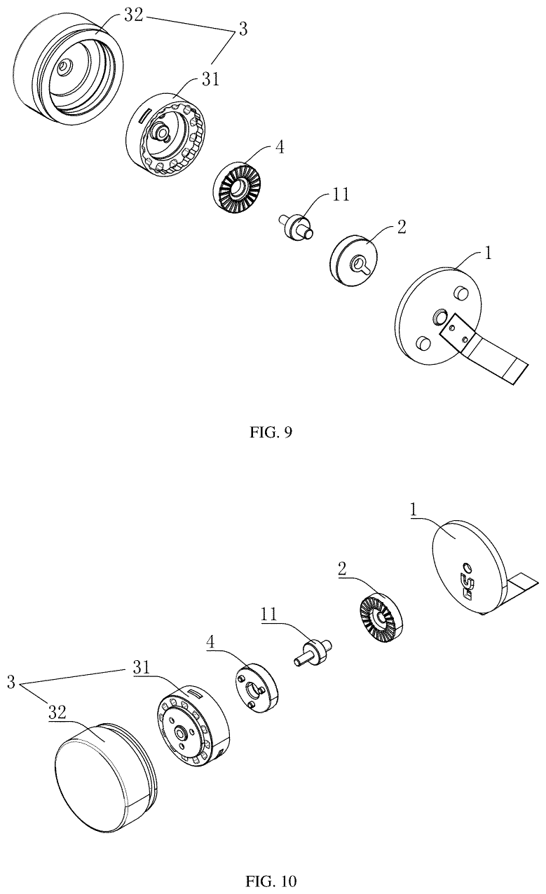

The technical solutions of the present disclosure can be applied to fields such as mice, keyboards, automotive dashboards, etc. In the field of mice, as shown in FIG. 1, FIG. 2, FIG. 3, and FIG. 4, the magnetic damping rotational structure of the present disclosure is configured as the scroll wheel of a mouse. The scroll wheel of a mouse can be designed with a single-scroll wheel structure or a dual-scroll wheel structure (the design of the dual-scroll wheel structure refers to the structural design of the second embodiment mentioned above). In the field of keyboards and automotive dashboards, as shown in FIG. 8, FIG. 9, and FIG. 10, the magnetic damping rotational structure of the present disclosure is configured as a volume-control scroll wheel (or as a page scrolling control device) of a keyboard or an automotive dashboard.

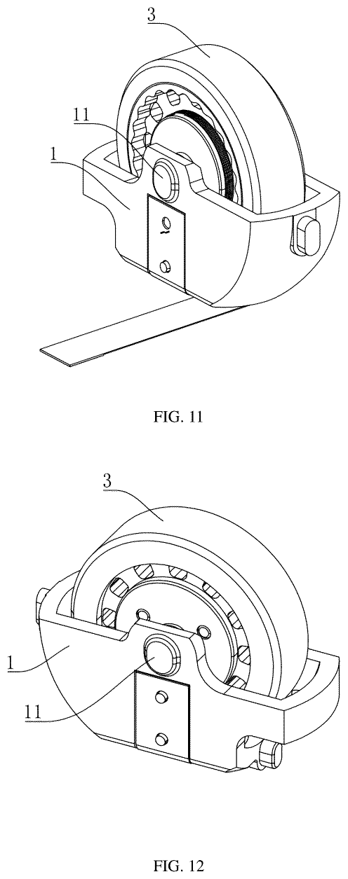

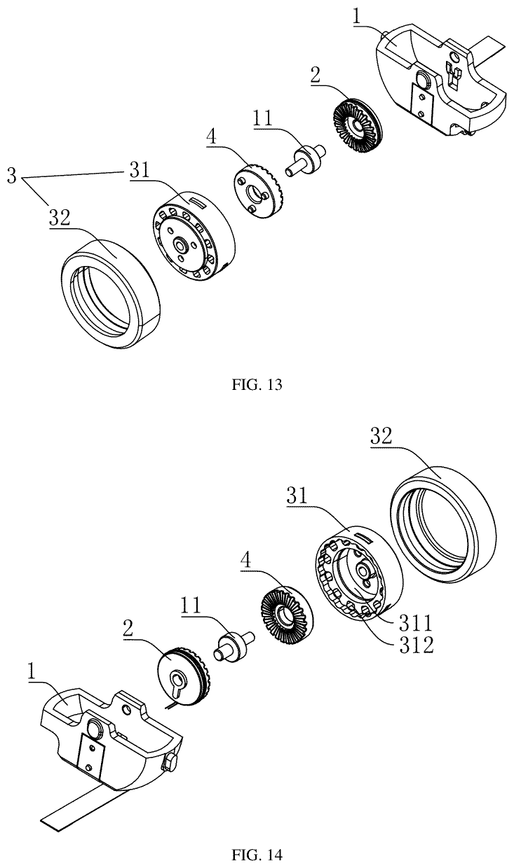

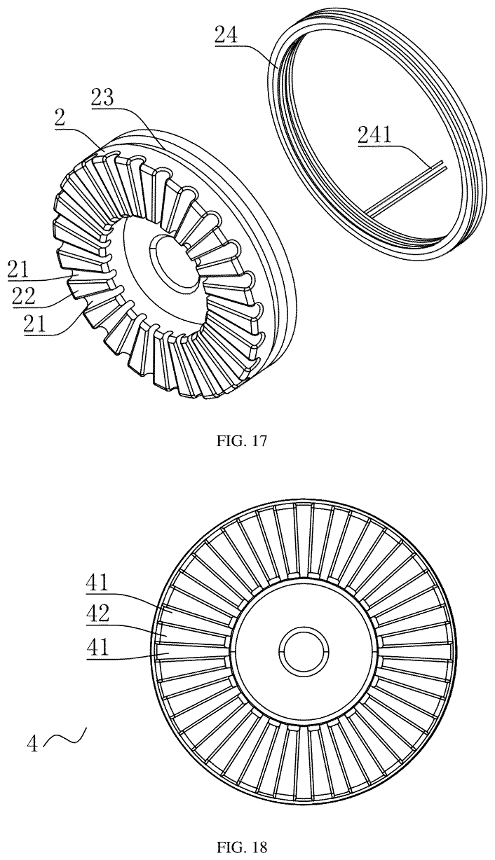

In another implementation, the present disclosure provides a magnetic damping roller structure, as shown in FIG. 11, FIG. 12, FIG. 13, and FIG. 14, which is a rotational structure that generates magnetic damping effect by combining a magnetic material with a magnetic coil 24. The roller structure can be applied to fields such as keyboard or mouse scroll wheels, automotive dashboard knobs, and control knobs in home appliances. The magnetic damping of the roller structure is primarily used to control the rotational speed of the rotational structure or to provide a damping effect. Therefore, the user's tactile experience is improved, and the rotation of the rotational structure becomes smoother and more controllable. The main structure of the present disclosure includes: a mounting base 1, a first annular bearing 2, and at least one second annular bearing 4. The first annular bearing 2 is fixed on the mounting base 1, and at least one side surface of the first annular bearing 2 is uniformly arranged with a plurality of first grooves 21. A first protrusion 22 is formed between adjacent two first grooves 21. The second annular bearing 4 is rotatably arranged on the mounting base 1. The second annular bearing 4 and the first annular bearing 2 are coaxially arranged together. The surface of one side of the second annular bearing 4 facing the first protrusion 22 is uniformly arranged with a plurality of second grooves 41, and a second protrusion 42 is formed between adjacent two second grooves 41. At least one magnetic coil 24 is arranged on the first annular bearing 2, and the magnetic coil 24 is configured to adjust the magnetic strength of the first annular bearing 2. As shown in FIG. 16 and FIG. 17, at least two electrodes 241 are provided on the magnetic coil 24, and the electrodes 241 are adopted to be connected to an external circuit. There is a gap between the first protrusion 22 and the second protrusion 42, and the first protrusion 22 and the second protrusion 42 are arranged in a one-to-one correspondence and generate attraction magnetic forces. Mounting base 1 is adopted to fix the first annular bearing 2, so that the first annular bearing 2 acts as a stator, and the second annular bearing 4 is coaxially rotatably connected to the first annular bearing 2, acting as a rotor. The first annular bearing 2 and the second annular bearing 4 can be made of magnetically attracted metal bearings or magnetic bearings with magnetic field strength. When the magnetic coil 24 is connected to the circuit, the magnetic attraction strength between the first annular bearing 2 and the second annular bearing 4 will change, thereby adjusting the damping magnitude between the first annular bearing 2 and the second annular bearing 4 during rotation.

The mounting base 1 is configured to mount and fix various structural components. Different functional components can be set at the mounting base 1 according to functional requirements, such as a rotatable switch, a photoelectric switch, etc. The mounting base 1 is arranged with a connecting shaft 11, which in some embodiments is configured as a metal bearing to ensure the structural strength and durability of the rotational structure. The first annular bearing 2 is sleeved on the connecting shaft 11 and fixed on the mounting base 1. At least one side surface of two side surfaces of the first annular bearing 2 is uniformly arranged with a plurality of first grooves 21, and the plurality of first grooves 21 extend in a direction deviating from an axis of the first annular bearing 2. A first protrusion 22 is formed between adjacent two first grooves 21.

It should be noted that, taking a mouse scroll wheel as an example, existing magnetic-damping mouse wheels generally have fixed internal structures and fixed magnetic strength. As a result, the notched feedback and damping feedback during rotation are typically fixed and not adjustable. Users are therefore unable to adjust the magnitude of the damping feedback according to personal preference.

In the present disclosure, a magnetic field strength of the first annular bearing 2 can be adjusted by controlling a magnitude and a direction of a current applied to the magnetic coil 24, thereby adjusting a magnetic attraction force between the first protrusion 22 and the second protrusion 42, such that a damping magnitude during rotation of the second annular bearing 4 is adjustable. When the second annular bearing 4 is rotated, variation of the damping force generated by magnetic attraction between the first annular bearing 2 and the second annular bearing 4 produces tactile notched feedback having adjustable heaviness. In addition, kinetic energy generated during rotation of the second annular bearing 4 can be converted into electrical energy, thereby achieving an energy-harvesting effect. The solution may be applied to devices such as mice, keyboards, and automotive instrument panels. When an outer ring wheel 3 accelerates to rotate, torque inertia enables the second annular bearing 4 to rotate rapidly until rotational speeds of the outer ring wheel 3 and the second annular bearing 4 decrease to a level at which damping can no longer be overcome, thereby coming to a stop.

Furthermore, as shown in FIG. 11 and FIG. 13, at least one of the first annular bearing 2 and the second annular bearing 4 is a magnetically attractive annular bearing. This causes the first protrusion 22 and the second protrusion 42 to be attracted to each other due to magnetic attraction. In a first embodiment of the present implementation, the first annular bearing 2 is a magnetically attractive annular bearing, and the second annular bearing 4 is a magnetically attractable metal bearing. In a second embodiment of the present implementation, the second annular bearing 4 is a magnetically attractive annular bearing, and the first annular bearing 2 is a magnetically attractable metal bearing. In a third embodiment of the present implementation, both the first annular bearing 2 and the second annular bearing 4 are magnetically attractive annular bearings.

In the first embodiment of the present implementation, the first annular bearing 2 is a magnetically attractive annular bearing, and the second annular bearing 4 is a magnetically attractable metal bearing. Since the first annular bearing 2 is magnetically attractive, the first protrusion 22 with magnetic attractive can magnetically attract the second protrusion 42. When the magnetic coil 24 is energized, the magnetic attraction of the first annular bearing 2 is suppressed or enhanced, thereby changing the magnetic attraction between the first protrusion 22 and the second protrusion 42. As a result, both a damping magnitude and a notched force during rotation of the roller are adjustable, enabling adjustment of tactile feel. Meanwhile, kinetic energy generated during rotation of the roller can be converted into electrical energy for energy harvesting.

In the second embodiment of the present implementation, the second annular bearing 4 is a magnetically attractive annular bearing, and the first annular bearing 2 is a magnetically attractable metal bearing. Since the second annular bearing 4 is magnetically attractive, even when the magnetic coil 24 is not energized, the second protrusion 42 with magnetic attractive can still magnetically attract the first protrusion 22. When the magnetic coil 24 is energized, the magnetic attraction of the first annular bearing 2 is suppressed or enhanced, thereby changing the magnetic attraction between the first protrusion 22 and the second protrusion 42. As a result, both a damping magnitude and a notched force during rotation of the roller are adjustable, enabling adjustment of tactile feel. Additionally, since the second annular bearing 4 is magnetic, when the second annular bearing 4 rotates, the magnetic coil 24 on the first annular bearing 2 cuts the magnetic flux lines of the second annular bearing 4, thereby generating electrical energy in the magnetic coil 24, which may be collected by an energy storage device of the mouse, achieving the technical effect of converting kinetic energy into electrical energy.

In the third embodiment of the present implementation, since both the first annular bearing 2 and the second annular bearing 4 are magnetically attracted annular bearings, when the magnetic coil 24 is not energized, the first protrusion 22 and the second protrusion 42 attract each other under the action of magnetic attraction, generating a significant magnetic damping effect when the second annular bearing 4 rotates. When the magnetic coil 24 is energized, the magnetic attraction of the first annular bearing 2 is suppressed or enhanced, thereby changing the magnetic attraction between the first protrusion 22 and the second protrusion 42. As a result, both a damping magnitude and a notched force during rotation of the roller are adjustable, enabling adjustment of tactile feel. Similarly to the second embodiment, since the second annular bearing 4 is magnetic, when the second annular bearing 4 rotates, the magnetic coil 24 on the first annular bearing 2 cuts the magnetic flux lines of the second annular bearing 4, thereby generating electrical energy in the magnetic coil 24, which may be collected by an energy storage device of the mouse, achieving the technical effect of converting kinetic energy into electrical energy.

In the first embodiment and the third embodiment, the arrangement of the first grooves 21 weakens the magnetism at corresponding locations. Therefore, the magnetic attraction on the side surface of the first annular bearing 2 can be evenly distributed among several first protrusions 22. The outer ring wheel 3 is sleeved on the connecting shaft 11. the second annular bearing 4 is disposed at a center of the outer ring wheel 3 and adjacent to a side surface of the first annular bearing 2. A plurality of second grooves 41 are evenly distributed on a side surface of the second annular bearing 4 facing the first annular bearing 2. The second grooves 41 extend in a direction away from the center of the second annular bearing 4, and the second protrusion 42 is formed between adjacent two second grooves 41. Similarly, the arrangement of the second grooves 41 weakens the magnetism at corresponding locations. Therefore, the magnetic attraction on the side surface of the second annular bearing 4 can be evenly distributed among several second protrusions 42. The first protrusions 22 and the second protrusions 42 are arranged in a one-to-one correspondence through magnetic attraction, with a gap maintained between the first protrusions 22 and the second protrusions 42. In some embodiments, a shaft step is coaxially provided on the connecting shaft 11 between the first protrusions 22 and the second protrusions 42. The first protrusions 22 and the second protrusions 42 are maintained with spacing and coaxial connection by the shaft step. In some embodiments, the shaft step is integrally formed with the connecting shaft 11, and both the shaft step and the connecting shaft 11 are made of non-magnetic materials to avoid interference with the magnetic field of the first protrusions 22 and the second protrusions 42.

The first annular bearing 2, the second annular bearing 4, and the outer ring wheel 3 are directly or indirectly sleeved on the connecting shaft 11. When the outer ring wheel 3 is rotated, the second annular bearing 4 rotates synchronously. At this time, the axial magnetic attraction between two adjacent magnetic attraction surfaces of the second annular bearing 4 and the first annular bearing 2 changes, thereby causing the damping magnitude to change when the outer ring wheel 3 rotates, leading to different tactile feedback.

In some embodiments, the first annular bearing 2 and two second annular bearings 4 are coaxially arranged on the connecting shaft 11, and both the first annular bearing 2 and the connecting shaft 11 are fixedly connected to the mounting base 1. A plurality of first grooves 21 are evenly formed on both side surfaces of the first annular bearing 2. The first protrusion 22 is formed between two adjacent first grooves 21. The two second annular bearings 4 are rotatably arranged on the mounting base 1 respectively, and each second annular bearing is provided with a plurality of second grooves 41 on the side surface facing the first protrusion 22. The second protrusion 42 is formed between two adjacent second grooves 41. Gaps are provided between each second protrusion 42 and the corresponding side surface of the first protrusion 22, and the first protrusion 22 and the second protrusion 42 are arranged in a one-to-one correspondence and generate magnetic attraction forces.

Furthermore, the magnetic poles of the first protrusion 22 and the second protrusion 42 are opposite. It is understandable that the opposite magnetic poles of the first protrusion 22 and the second protrusion 42 can cause the protrusions to attract each other, resulting in a better magnetic damping effect.

Furthermore, as shown in FIG. 11 and FIG. 13, the second annular bearing 4 is a magnetically attractive annular bearing. The magnetic coil 24 is configured to adjust the magnetic strength of the first annular bearing 2, or to cut the magnetic flux lines of the second annular bearing 4 in a rotating state to generate electrical energy, as described in the second embodiment and the third embodiment.

Furthermore, as shown in FIG. 13 and FIG. 17, an annular groove 23 is formed on an outer periphery of the first annular bearing 2, and the magnetic coil 24 is wound around the annular groove 23 in a circumferential direction of the first annular bearing 2. In the present embodiment, the annular groove 23 is formed on the outer periphery of the first annular bearing 2, so that the magnetic coil 24 can be wound in the annular groove 23, and ultimately the outer wall of the first annular bearing 2 can be kept flush, making the overall roller structure more compact and aesthetically pleasing.

Furthermore, the magnetic coil 24 is a copper coil. It is understood that the copper coil has excellent conductivity, enabling efficient current transmission and reducing energy loss (such as heat generation). Copper coil can generate strong magnetic fields and is sensitive to electromagnetic interference. The copper coil can efficiently cut the magnetic flux lines of the second annular bearing 4.

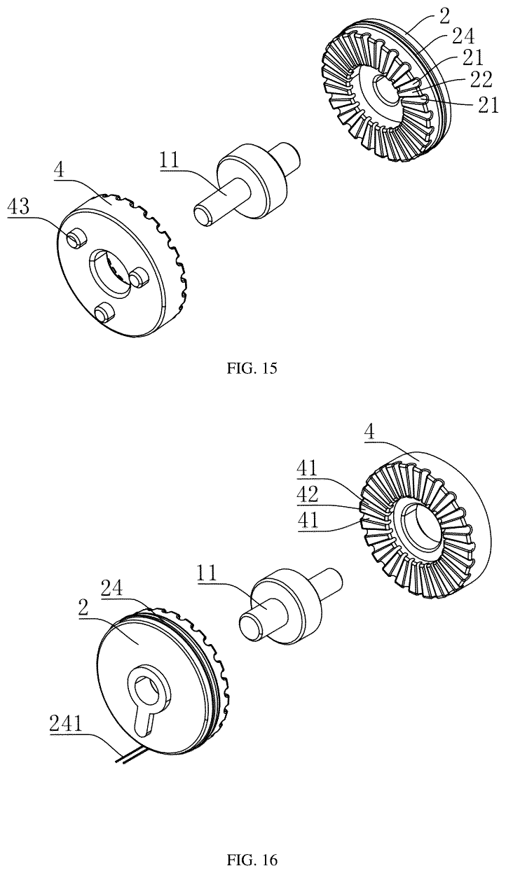

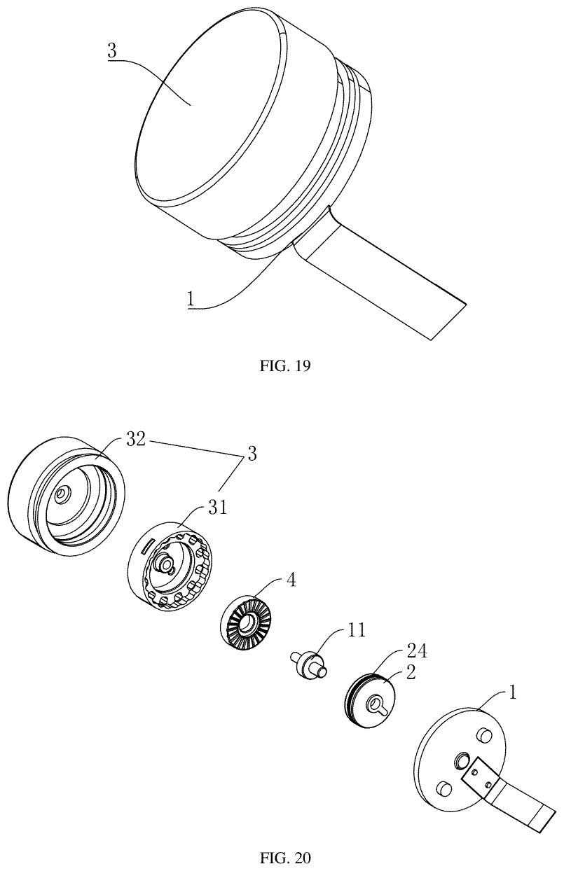

Furthermore, as shown in FIG. 15, FIG. 16 and FIG. 18, a quantity of the first grooves 21 is the same as a quantity of the second grooves 41, a size of the first protrusion 22 is the same as a size of the second protrusion 42, and a shape of the first protrusion 22 is the same as a shape of the second protrusion 42.

In order to provide a clearer feedback of the rotation of the magnetic damping roller structure, it is essential that the quantity of the first grooves 21 is the same as the quantity of the second grooves 41, the size of the first protrusion 22 is the same as the size of the second protrusion 42, and the shape of the first protrusion 22 is the same as the shape of the second protrusion 42.

Furthermore, as shown in FIG. 15 and FIG. 16, both the first groove 21 and the second groove 41 are U-shaped grooves.

In some embodiments, both the first grooves 21 and the second grooves 41 are U-shaped grooves. While in some other embodiments, the first grooves 21 and the second grooves 41 can also be V-shaped grooves. The V-shaped grooves allow the protrusions (the first protrusion 22 and the second protrusion 42) to have a structure that is wider at the bottom and narrower at the top. This structural design allows the magnetic attraction force on the magnetic side surfaces of the annular bearings (the first annular bearing 2 and the second annular bearing 4) to be concentrated at the top of the protrusions (the first protrusion 22 and the second protrusion 42) along the slope of the V-shaped grooves. As a result, the notched feedback between the first annular bearing 2 and the second annular bearing 4 is clearer and the magnetic damping effect is improved.

Furthermore, as shown in FIG. 13 and FIG. 14, an outer ring wheel 3 is coaxially mounted on the second annular bearing 4. The outer ring wheel 3 is detachably connected to the second annular bearing 4. The outer ring wheel 3 is a metal rim. A plurality of positioning pins 43 are provided on the second annular bearing 4, and the second annular bearing 4 is fixedly connected to the outer ring wheel 3 through the positioning pins 43. The metal rim has a larger mass, resulting in a greater rotational inertia for an outer rim 32, thus extending the rolling stroke. The second annular bearing 4 is connected to the outer ring wheel 3 through the positioning pins 43, which prevent slippage between the second annular bearing 4 and the outer ring wheel 3. In some embodiments, the second annular bearing 4 and the outer ring wheel 3 are detachably connected.

Furthermore, as shown in FIG. 13 and FIG. 14, the outer ring wheel 3 includes a grating clamp ring 31 and the outer rim 32. The grating clamp ring 31 is coaxially arranged with the second annular bearing 4. A plurality of light pass holes 312 are formed on a circumference of the grating clamp ring 31, and an extending direction of the light pass holes 312 is parallel to an axial direction of the grating clamp ring 31. The outer rim 32 is sleeved on an outer wall of the grating clamp ring 31. A clearance groove 311 is formed at an axial center of the grating clamp ring 31. The clearance groove 311 is configured to accommodate the first annular bearing 2 and the second annular bearing 4. The first annular bearing 2 and the second annular bearing 4 are arranged in the clearance groove 311 at the axial center of the grating clamp ring 31, which makes the entire roller structure more compact and has a higher degree of integration. Moreover, the wheel structure formed by the first annular bearing 2, the second annular bearing 4 and the grating clamp ring 31 is more rational.

The present disclosure further provides a damping adjustment method based on the magnetic damping roller structure described in any one of the first aspects, the damping adjustment method includes the following steps:
Step 1: Receiving an adjustment instruction via electrodes 241 of the magnetic coil 24 and adjusting a magnitude and direction of current in the magnetic coil 24 on the first annular bearing 2 according to the instruction to change the magnetic attraction between the first annular bearing 2 and the second annular bearing 4, thereby changing the damping between the first protrusion 22 and the second protrusion 42. The second annular bearing 4 rotates by the drive of the outer ring wheel 3, the first protrusion 22 is arranged on the first annular bearing 2, and the second protrusion 42 are arranged on the second annular bearing 4.
Step 2: Driving, when the outer ring wheel 3 is rolled by the user, the second annular bearing 4 to rotate by the outer ring wheel 3.
Step 3: Rotating the second annular bearing 4 to cause relative displacement between the first protrusion 22 on the first annular bearing 2 and the second protrusion 42 on the second annular bearing 4. The first protrusion 22 and the second protrusion 42 are in the one-to-one correspondence and attract each other.
Step 4: Changing the magnetic attraction between the first protrusion 22 and the second protrusion 42 to generate damping between the first protrusion 22 and the second protrusion 42.
Step 5: Adjusting the current in the magnetic coil 24 on the first annular bearing 2 to increase or decrease the magnetic attraction force of the first annular bearing 2, thereby increasing or decreasing the damping between the first protrusion 22 and the second protrusion 42. Refer to the first embodiment, the second embodiment and the third embodiment described above for details.

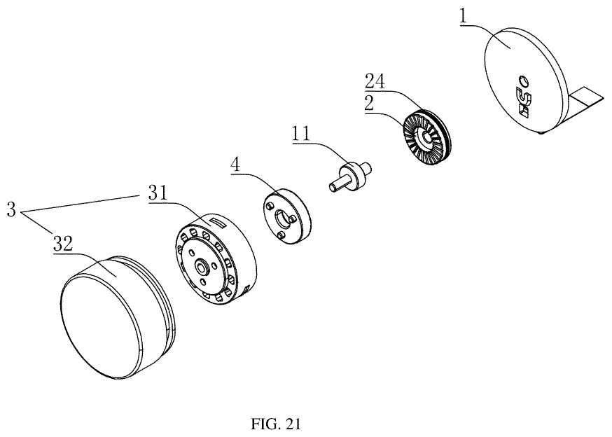

The present disclosure can be applied to fields such as mice, keyboards, and automotive dashboards. In the field of mice, as shown in FIG. 11, FIG. 12, FIG. 13, and FIG. 14, the adjustable-damping roller structure of the present disclosure is configured as a mouse scroll wheel. In the fields of keyboards and automotive dashboards, as shown in FIG. 19, FIG. 20, and FIG. 21, the adjustable-damping roller structure of the present disclosure can be configured as a volume control scroll wheel (or a page scrolling control device) for a keyboard or an automotive dashboard.

Therefore, the present disclosure further provides a mouse, which includes a mouse housing, a circuit board, and a magnetic damping roller structure as described above. The mouse housing is arranged with a plurality of buttons. The circuit board is arranged inside the mouse housing, and is arranged with a light-emitting component and a photosensitive receiving component. The magnetic damping roller structure is arranged inside the mouse housing. The light-emitting component and the photosensitive receiving component are respectively arranged at two sides of the magnetic damping roller structure. The light-emitting component and the photosensitive receiving component are respectively arranged corresponding to two ends of the light pass hole 312.

In some embodiments, the light-emitting component and the photosensitive receiving component are arranged at the same end of the light pass hole 312. The other end of the light pass hole 312 is arranged with a light-reflection plate, and the light-reflection plate is used to reflect light emitted from the light pass hole 312, so that the light is reflected onto the photosensitive receiving component. This achieves the technical effect of scroll wheel rotating induction.

Obviously, the above embodiments are only examples provided for a clear description, and do not limit implementations. For ordinary skilled in the art, other forms of changes or modifications can be made based on the above description. It is not necessary and impossible to exhaustively list all implementations here. The obvious changes or modifications arising from this are still within the protection scope of the present disclosure.

What is claimed is:

1. A magnetic damping roller structure, comprising:
a mounting base;
a first annular bearing, fixed at the mounting base, wherein at least one side surface of the first annular bearing is uniformly arranged with a plurality of first grooves, and a first protrusion is formed between adjacent two first grooves; and
at least one second annular bearing, rotatably arranged at the mounting base, wherein the second annular bearing and the first annular bearing are coaxially arranged together, a plurality of second grooves are uniformly arranged at a surface of one side of the second annular bearing facing the first protrusion, and a second protrusion is formed between adjacent two second grooves;
wherein a gap is formed between the first protrusion and the second protrusion, and the first protrusion and the second protrusion are arranged in one-to-one correspondence and generate attraction magnetic forces.

2. The magnetic damping roller structure according to claim 1, wherein the first annular bearing and the second annular bearing are integrally formed annular magnetic bearings, and the first protrusion and the second protrusion are protruding structures.

3. The magnetic damping rotational structure according to claim 2, wherein a quantity of the first grooves is the same as a quantity of the second grooves, a size of the first protrusion is the same as a size of the second protrusion, and a shape of the first protrusion is the same as a shape of the second protrusion.

4. The magnetic damping rotational structure according to claim 2, wherein the first grooves and the second grooves are all V-shaped grooves.

5. The magnetic damping rotational structure according to claim 2, wherein an outer ring wheel is coaxially arranged at the second annular bearing, and the outer ring wheel is detachably connected to the second annular bearing.

6. The magnetic damping rotational structure according to claim 5, wherein a plurality of positioning pins are arranged at the second annular bearing, and the second annular bearing is fixedly connected to the outer ring wheel through the positioning pins.

7. The magnetic damping rotational structure according to claim 5, wherein the outer ring wheel comprises:
a grating clamp ring, wherein the grating clamp ring and the second annular bearing are coaxially arranged together, a plurality of light pass holes are arranged in a circumferential direction of the grating clamp ring, and an extension direction of the through holes is parallel to an axis direction of the grating clamp ring; and
an outer rim, sleeved on an outer side wall of the grating clamp ring.

8. The magnetic damping rotational structure according to claim 7, wherein a clearance groove is arranged at the axis of the grating clamp ring and is configured to accommodate the first annular bearing and the second annular bearing.

9. The magnetic damping rotational structure according to claim 7, wherein the outer rim is a metal rim.

10. The magnetic damping rotational structure according to claim 1, wherein at least one magnetic coil is arranged on the first annular bearing, the magnetic coil is configured to adjust a magnetic magnitude of the first annular bearing, at least two electrodes are arranged on the magnetic coil and the two electrodes are configured to be connected to an external circuit.

11. The magnetic damping rotational structure according to claim 10, wherein at least one of the first annular bearing and the second annular bearing is a magnetically attractive annular bearing.

12. The magnetic damping roller structure according to claim 10, wherein the second annular bearing is the magnetically attractive annular bearing, the magnetic coil is configured to adjust a magnetic magnitude of the first annular bearing, or to cut magnetic flux lines of the second annular bearing in a rotating state to generate electrical energy.

13. The magnetic damping roller structure according to claim 10, wherein an annular groove is formed on an outer periphery of the first annular bearing, and the magnetic coil is wound around the annular groove in a circumferential direction of the first annular bearing.

14. The magnetic damping roller structure according to claim 10, wherein the magnetic coil is a copper coil.

15. The magnetic damping roller structure according to claim 10, wherein a quantity of the first grooves is the same as a quantity of the second grooves, a size of the first protrusion is the same as a size of the second protrusion, and a shape of the first protrusion is the same as a shape of the second protrusion.

16. The magnetic damping roller structure according to claim 10, wherein the first grooves and the second grooves are all U-shaped grooves.

17. The magnetic damping roller structure according to claim 10, wherein an outer ring wheel is coaxially arranged at the second annular bearing, and the outer ring wheel is detachably connected to the second annular bearing, the outer ring is a metal ring, and a plurality of positioning pins are arranged at the second annular bearing, and the second annular bearing is fixedly connected to the outer ring wheel through the positioning pins.

18. The magnetic damping roller structure according to claim 17, wherein the outer ring wheel comprises:
a grating clamp ring, wherein the grating clamp ring and the second annular bearing are coaxially arranged together, a plurality of light pass holes are arranged in a circumferential direction of the grating clamp ring, and an extension direction of the through holes is parallel to an axis direction of the grating clamp ring; and
an outer rim, sleeved on an outer side wall of the grating clamp ring;
wherein a clearance groove is arranged at an axial center of the grating clamp ring and is configured to accommodate the first annular bearing and the second annular bearing.
